(19) United States
(12) Patent Application Publication
(10) Pub. No.: US 2002/0009325 A1
(43) Pub. Date: Jan. 24, 2002

(54) Fluid chargeable implement

(76) Inventor: Scot R. Young, Grand Valley (CA)

Correspondence Address: Swanson Midgley LLC, 2420 Pershing Road Suite 400, Kansas City, MO, 64108, US

(21) Appl. No.: 09/858,367

(22) Filed: May 16, 2001

(30) Foreign Application Priority Data
Jul. 18, 2000 (GB) 174449.0

(51) Int. Cl. B43K 1/06; A47L 13/30; B43K 5/18

(52) U.S. Cl. 401/265; 401/263

(57) ABSTRACT

A fluid chargeable implement comprises a hollow, elongate body, the body having one or more apertures located in a wall or walls thereof to enable in-flow and out-flow of fluid to and from an inside of said body. An applicator material (not shown) is supported by the body. A handle (not shown) and a mechanism for controlling the flow rate of the out-flow are attached to the body.

This invention relates to an implement that can be charged to dispense a fluid, such as sealant, paint, germicide, cleaning fluid, or water.

The use of an implement to apply a fluid to surfaces such as glass, walls and panels is widely practised. In its simplest form, this device may take the form of a sponge or a cloth. More sophisticated implements typically have a body which supports a handle and at least one of a resilient rubber scraper, a sponge, cloth material and/or bristles.

The fundamental problem associated with, for example, cleaning tasks, such as window cleaning, is that the applicator implement frequently requires an ancillary operation to either recharge the implement once the cleaning fluid held therein has been dispensed, or apply the cleaning fluid to the window whereby it can be used to clean the glass.

The present invention seeks to overcome this problem.

According to a first aspect of the invention, there is provided a fluid chargeable implement comprising a hollow elongate body, the body having one or more apertures located in a wall or walls thereof to enable in-flow and out-flow of fluid to and from the inside of the body, an applicator material supported by the body, a handle, and means for controlling the flow rate of the said out-flow.

Preferred and/or optional features of the present invention are set forth in claims 2 to 11.

According to a second aspect of the invention, there is provided a window cleaning implement comprising a hollow elongate body, a window cleaning material supported by the body, and a handle, the body having one or more apertures located in a wall or walls thereof to enable quick in-flow and slow out-flow of cleaning fluid to and from the inside of the body.

The invention will now be more particularly described, by way of example, with reference to the accompanying drawings, wherein

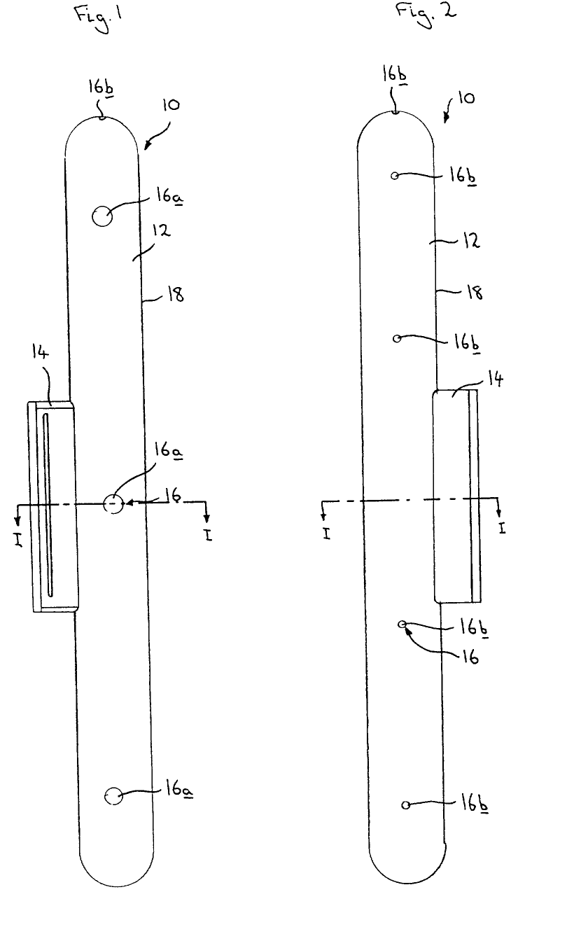

FIG. 1 is a side view of one embodiment of a fluid chargeable implement with its handle and applicator material removed, according to the first aspect of the present invention,

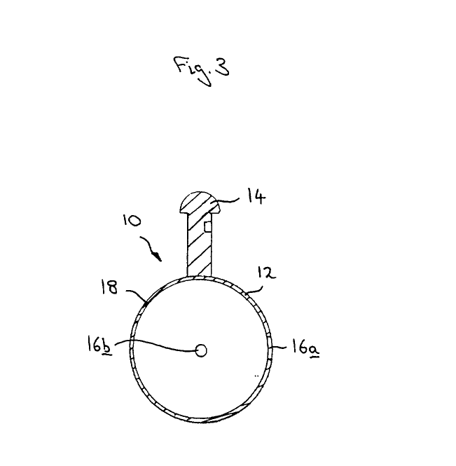

FIG. 2 is a view similar to that of FIG. 1, but from the other side of the implement; and

FIG. 3 is a cross-sectional view taken along line I-I in FIGS. 1 and 2.

Referring to the drawings, one embodiment of a fluid chargeable implement 10 shown therein comprises a hollow elongate body 12 and an adaptor 14 integrally formed thereon.

The implement 10 also comprises an applicator material (not shown) which is supported by the body 12. This may typically be either a non-abrasive or slightly abrasive porous fabric which is fashioned to fit around or substantially around the hollow body 12.

Alternatively, the material may be a resilient polymer, typically rubber, tongue which can act as a scraper, and in this case the hollow body 12 is suitably formed with means for supporting the tongue.

The material may also be in the form of bristles, and in this case the hollow body 12 is suitably formed with means for supporting the bristles.

The hollow body 12 and adaptor 14 are typically molded from a rigid plastics material. In this embodiment, the hollow elongate body 12 is molded in the form of a cylinder having hemispherical ends. However, the body 12 is not limited to this shape and may be molded to any suitable shape.

Apertures 16 are formed in a wall or walls 18 of the hollow elongate body 12. A first set of three apertures 16a are formed through the wall 18 in one side of the cylindrical body 12. The apertures 16a are in spaced apart relationship relative to each other and generally follow the longitudinal extent of the cylindrical body 12. A second set of four apertures 16b are also formed through the wall 18 in another side of the cylindrical body 12. The apertures 16b are in spaced apart relationship relative to each other and also generally follow the longitudinal extent of the cylindrical body 12. The sides of the cylindrical body 12, in which the two sets of apertures 16a and 16b are formed, are typically opposite or substantially opposite each other.

The apertures 16a are of a first size, and the apertures 16b are of a second size, which is smaller than the first size. This allows the flow rate of fluid through the first sized apertures 16a to be greater than the flow rate through the second sized apertures 16b.

The number of apertures 16a and 16b are not limited to the numbers stated above, and one or more of the apertures 16b may also be formed in one or both hemispherical ends of the cylindrical body 12.

The adaptor 14 permits interchangeable handles (not shown) to be attached to the body 12. This provides for use of handles of varying lengths dependent upon necessity.

Obviously, the body 12 may be provided with an integral handle formed in place of the adaptor 14 where necessary.

In use, the implement 10, in this case, for example, being a window cleaning implement, is first charged with cleaning fluid. This takes the form of immersing at least the elongate body 12 in a container (not shown) holding cleaning fluid in such a manner that the large sized apertures 16a face or substantially face the base of the container during immersion. This allows a relatively high rate of in-flow of fluid into the elongate body 12.

Once charged, the elongate body 12 is removed from the container and should be oriented such that, during a window cleaning operation, the small apertures 16b face or substantially face, as far as is practicable, the window sill and/or pane of glass of the window being cleaned. This allows a relatively low and continuous rate of out-flow of fluid from the elongate body 12, with relatively little spillage occurring from the large sized apertures 16a.

Since the applicator material, being in the form of a window cleaning material, is supported by the elongate body 12 in such a manner that, in use, the fluid from the small sized apertures 16b flows in or on to the window cleaning material, the material can be kept in a damp or wet state for an extended period before re-charging of the elongate body 12 is required.

In a first modification to the invention (not shown), an open or closed state of one or more of the apertures 16b may be controllable by a manually operable adjustment mechanism by which the apertures 16b can be set fully open or fully closed.

The adjustment mechanism may also be such that the apertures 16b could be set fully open, fully closed or to a degree therebetween.

This first modification would allow an out-flow flow rate to be easily determined by the user.

In a second modification to the invention (not shown), the in-flow apertures 16a may comprise a non-return mechanism by which discharge of fluid back through the apertures 16a is prevented.

In a third modification to the invention (not shown), one or more of the apertures 16a may also be controllable by a manually operable adjustment mechanism by which the apertures 16b can be set fully open or fully closed. The mechanism may take the form of a plug or bung by which a corresponding aperture 16a can be stoppered. This would allow use of the implement without letting a significant amount of fluid enter the body 12, and also allow use of the implement to be easily halted and restarted at a later time.

In a fourth modification to the invention (not shown), the flow rate of fluid discharge from the apertures 16b may be controlled by a wick system which inhibits fluid flow and which in use is arranged with one or more of the apertures 16b.

In a fifth modification to the invention (not shown), the flow rate of fluid discharge from the apertures 16b may be controlled by a tube system which restricts fluid flow and which in use is arranged with the one or more of the apertures 16b.

It is thus possible to provide a window cleaning implement that requires a re-charging operation to be performed less frequently.

The fluid rechargeable implement described above is given by way of example only and various modifications will be apparent to persons skilled in the art without departing from the scope of the invention. For example, the device is not limited to using an applicator material of the types mentioned hereinbefore, and any other suitable type of material may be used by the device and supported by the body 12.

1. A fluid chargeable implement comprising a hollow elongate body, the body having one or more apertures located in a wall or walls thereof to enable in-flow and out-flow of fluid to and from the inside of the body, an applicator material supported by the body, a handle, and means for controlling the flow rate of the said out-flow.

2. An implement as claimed in claim 1, wherein the control means controls the flow rate of the said out-flow relative to the flow rate of the said in-flow such that the out-flow flow rate is less than the in-flow flow rate.

3. An implement as claimed in claim 1 or claim 2, wherein the control means is in the form of at least two sizes of said apertures, one being of a first size and the second being of a second size smaller than the first size.

4. An implement as claimed in claim 3, wherein the first and second sized apertures are located on different sides of the body.

5. An implement as claimed in claim 4, wherein the said sides are opposite or substantially opposite each other.

6. An implement as claimed in claim 3 or claim 4, wherein at least one second sized aperture is located in at least one of the ends of the body.

7. An implement as claimed in claim 1, wherein the control means comprises an adjustment mechanism by which the size of at least one of the apertures is adjustable.

8. An implement as claimed in claim 1 or claim 2, wherein the control means comprises a wick system in use arranged with at least one of the apertures.

9. An implement as claimed in claim 1 or claim 2, wherein the control means comprises a tube system in use arranged with at least one of the apertures.

10. An implement according to any one of the preceding claims, wherein the body is cylindrical.

11. An implement as claimed in claim 10, wherein the ends of the cylindrical body are hemispherical.

12. A fluid chargeable implement substantially as hereinbefore described with reference to the accompanying drawings.

13. A window cleaning implement comprising a hollow elongate body, a window cleaning material supported by the body, and a handle, the body having one or more apertures located in a wall or walls thereof to enable quick in-flow and slow out-flow of cleaning fluid to and from the inside of the body.

14. A window cleaning implement substantially as hereinbefore described with reference
